(19) United States
(12) Patent Application Publication
(10) Pub. No.: US 2004/0233786 A1
(43) Pub. Date: Nov. 25, 2004

(54) USB disk watch

(76) Inventor: Shao-Chieh Ting, Banchiau City (TW)

Correspondence Address: Shao-Chieh Ting & Chun-Hsin Ting, P.O. Box No. 6-57, Junghe, Taipei, 235, TW

(21) Appl. No.: 10/443,916

(22) Filed: May 23, 2003

(51) Int. Cl. G04F 8/00; G04F 10/00

(52) U.S. Cl. 368/2

(57) ABSTRACT

The invention relates to a USB disk watch consisting a computer storage device-watch combination, providing users a portable, safe, and convenient device that also has the function of a watch. It is a portable storage device, on which there is a time display, fastened to a base by a latch-and-hatch unit on one end of the base. A wrist band goes through the two ends of the bottom of the base rendering the storage device watch-like and releasable without taking off the wrist band. After use, putting back the device is just as easy, resulting in this invention on which the function of a watch also exists.

### BACKGROUND OF THE INVENTION

(a) Field of the Invention

The invention relates to a Universal Serial Bus (USB) disk watch consisting a portable storage device fastened to a base, and the storage device is Flash Memory for storage.

(b) Description of the Prior Art

USB Disk is made up of Flash Memory as the main storage device also called portable storage device, which connected to the computer through USB connector provides data transfer and storage. Because of its high storage capacity and portability, the device is well received by the consumers.

As for the reasons above, most users carry the device on a string around their necks in fear of losing the device. However, most computer users presently are mostly office workers who wear their name tags as well as their cell phones around their necks, adding a storage device just worsens the situation.

The applicant, for the purpose of providing another option for carriage, devised the USB Disk Watch, employing latch-and-hatch design to wear the device on the wrist and adding a time display in place of a watch, offering a combination of functions of storage and time telling.

### SUMMARY OF THE INVENTION

The object of the invention is to provide a portable storage device which has a time display fastened to a base. The storage device contains one or a plurality of time displays, a connector, a time control circuit, a power source and a recharging unit. The portable storage device has a time display and recharges by the power of the computer through the connector.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective schematic view of the first preferred embodiment according to the invention.

FIG. 2 shows a perspective exploded view according to the invention.

FIG. 3 shows the vertical cross section view according to the invention.

FIG. 4 shows the vertical cross section view of the portable storage device according to the invention.

FIG. 5 shows the view of the circuit according to the invention.

FIG. 6-1 shows the schematic view of the second preferred embodiment according to the invention.

FIG. 6-2 shows the schematic view of the third preferred embodiment according to the invention.

FIG. 6-3 shows the schematic view of the fourth preferred embodiment according to the invention.

FIG. 7-1 shows the schematic view of the fifth preferred embodiment according to the invention.

FIG. 7-2 shows the schematic view of the sixth preferred embodiment according to the invention.

FIG. 7-3 shows the schematic view of the seventh preferred embodiment according to the invention.

FIG. 7-4 shows the schematic view of the eighth preferred embodiment according to the invention.

### DETAILED DESCRIPTION OF THE PREFERRED EMBODIMENTS

To better understand the characteristics and novelties of the invention, descriptions shall be given with the accompanying drawings hereunder.

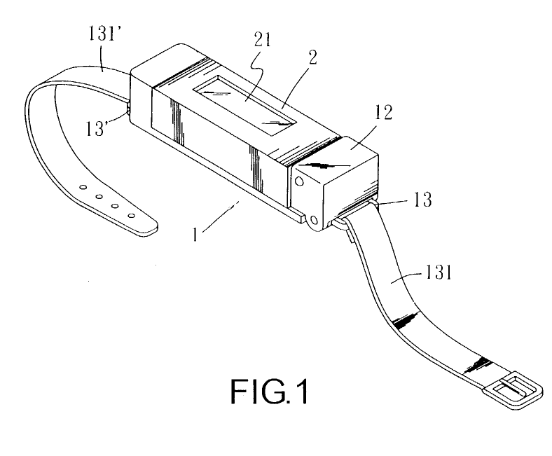

Referring to FIG. 1-3, there is no specific type requirement for the portable storage device. In FIG. 1, the device contains a time display (21) and a connector (22) for connections with a computer, a Personal Digital Assistant (PDA), or other read-write devices (not shown). On the opposite side of the connector is a fitting protrusion (23) as a part of the fastening structure for fastening the device to a base (1). As with the storage device, there is no specific type requirement for the time display. As in FIG. 1, a liquid crystal display (LCD) time display is illustrated.

The base (1) is of a uni-body construction, on which a fitting compartment (110) is formed for the purpose of fitting and fastening a portable storage device (2) at one end. At the other end of the base (1), a snap cover (122) of an “L” shaped hatch (12) has underneath an inwardly intruding stopper (123) which corresponds to snap holes 16,16′) on the fastening plates (11,11) for the purpose of snapping shut and fastening the device. The bottom of the hatch (12) has two pivot holes (121) to match rod holes (14) on the base (1) for a pivot rod (15) to go through all these holes to fasten the hatch (12) to the base (1). On both ends of the base (1) are two wrist band openings (13,13′) for the wrist band (131,131′). The wrist band openings (13,13′) are two symmetrical openings to be placed on any two symmetrical lateral sides of the base (1).

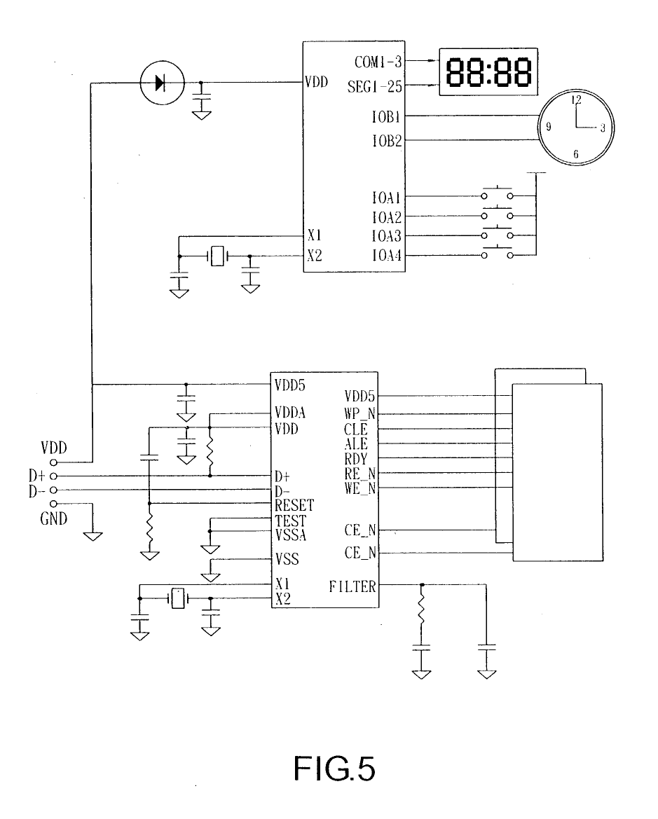

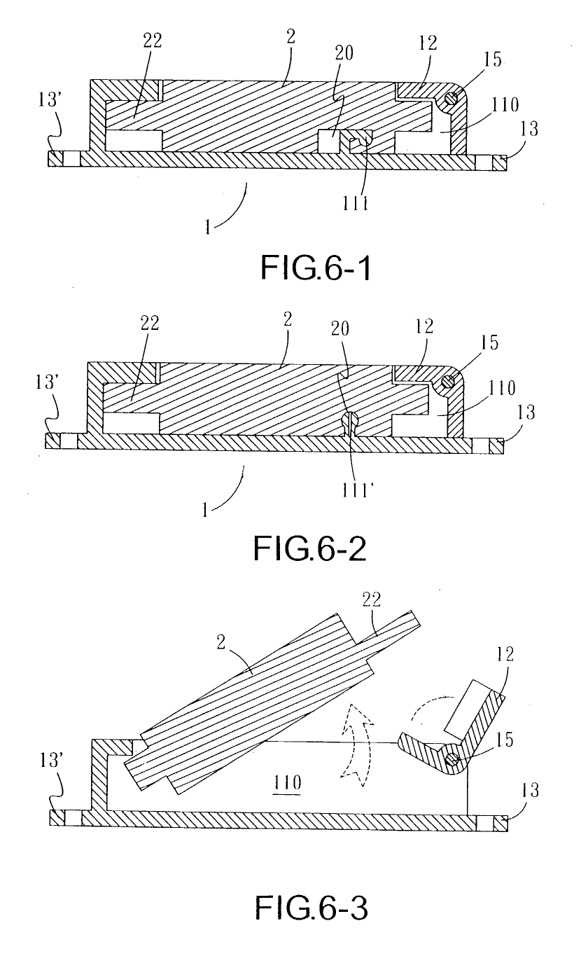

Referring to FIGS. 4 & 5, a main circuit board (25) of the portable storage device (2) are disposed at least a connector (22), a time display (21), a time control circuit (24), a power pack (28), a recharging unit (27) and a memory module (26).

The power pack (28) provides power for the time display (21); the recharging unit (27) can recharge drawing power from the the connected device such as a computer through the connector (22) in order to provide power for the time display (21) and the time control circuit (24) to function properly.

On one side of the portable storage device (2) are time adjustment buttons (29) for setting time and function switching. As for the memory module (26, the technology is already present in the portable storage device (2). No further discussion is necessary.

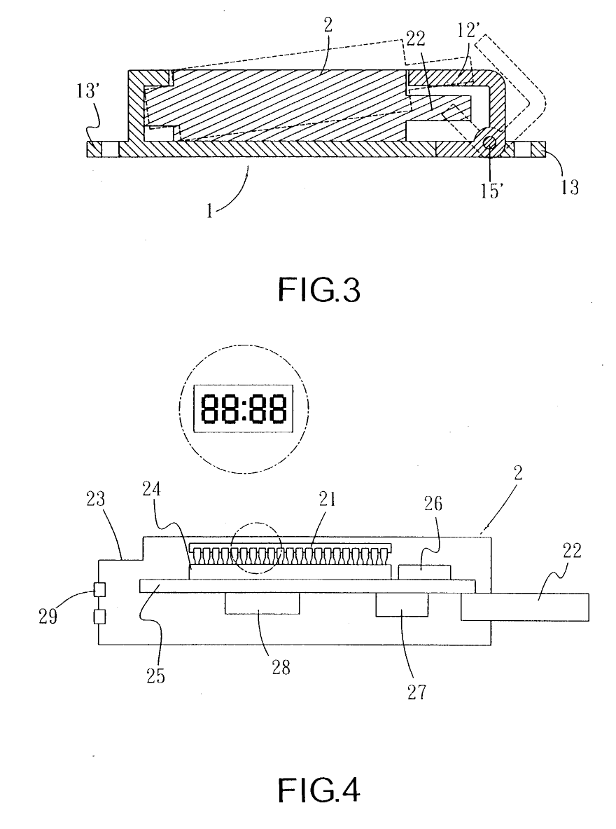

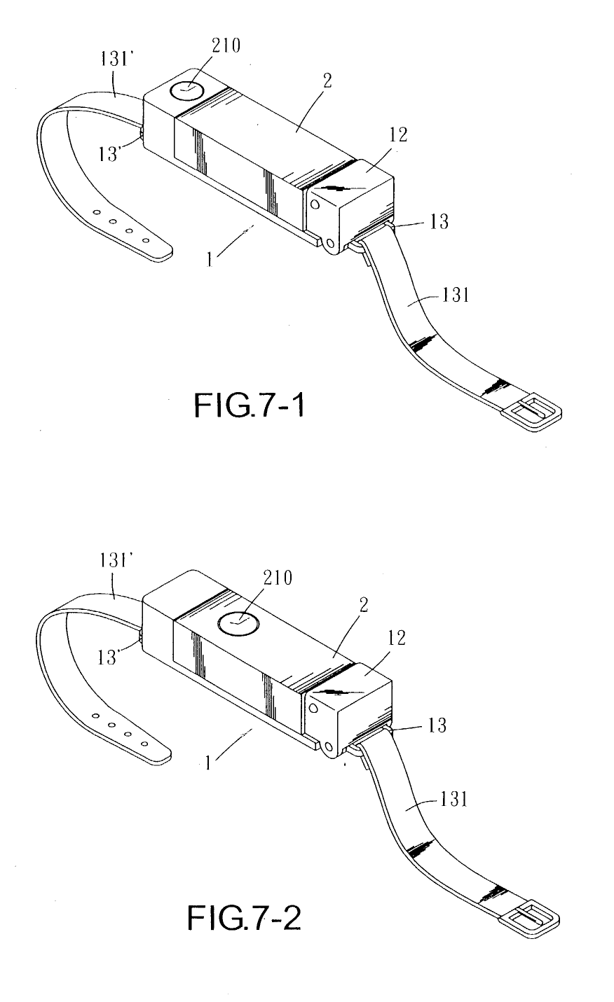

FIG. 6-1, 6-2 and 6-3 are the second, third and fourth preferred embodiments of the entire structural combination according to the invention respectively illustrating how the portable storage device (2) is fastened to the base (1). As illustrated, on the sides of the portable storage device (2), there can be two fastening grooves (20) which match two latches (111,111) on the base (1) for the purpose of fastening the portable storage device (2) to the base (1). FIG. 6-3 demonstrates how a user can release the portable storage device (2) from the fitting compartment (110) of the base (1) by lifting the hatch (12) around the pivot rod (15) to pop up the connector (22) and withdrawing the fitting protrusion (23) on the portable storage device (2). To put back the device (2) with the base (1), simply reverse the release order and snap shut tight the connector (22) of the device (2) by the hatch (12).

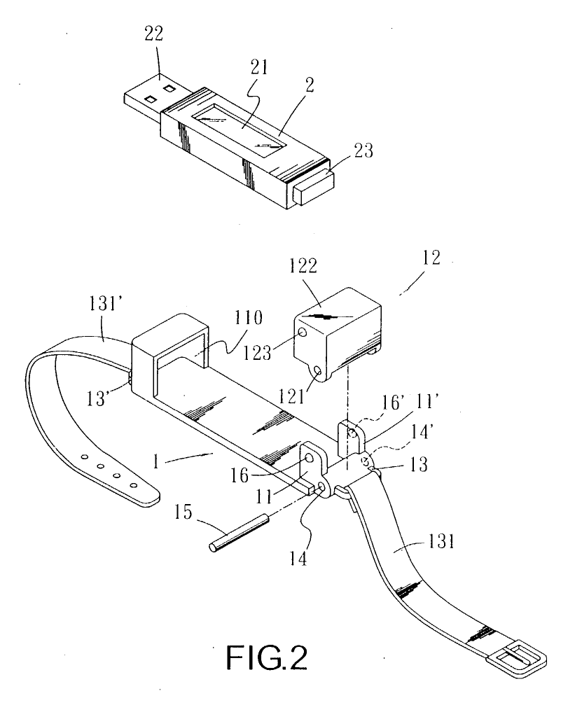

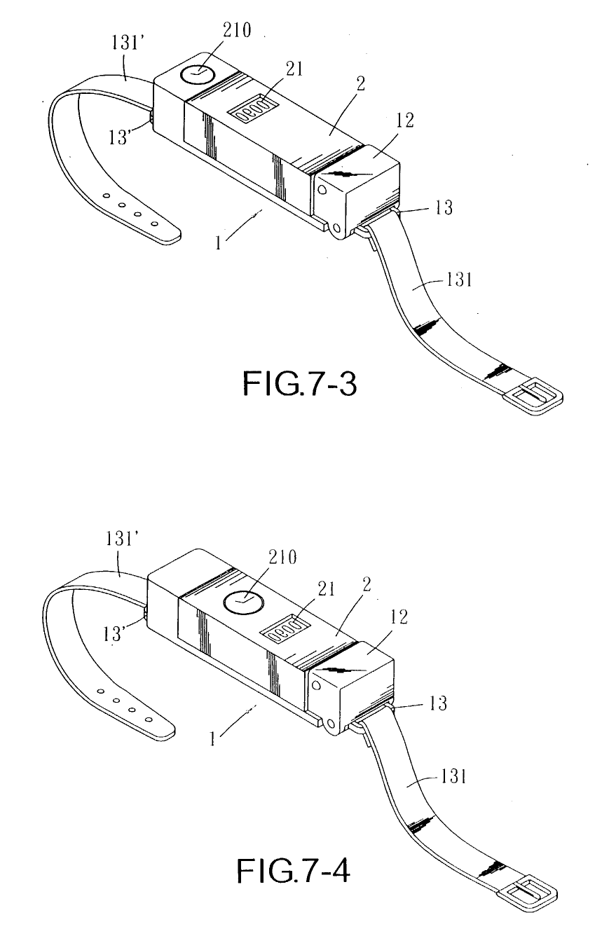

FIG. 7-1 shows how a clock (210) being placed on the base (1) while all other structures of the portable storage device (2) and the base (1) remain unchanged can drastically improve the conventional use of a portable storage device (2). As shown in FIG. 7-2, the clock (210) can be placed on the device (2), or, as in FIG. 7-3, one clock (210) can be placed on the base (1) as well as another time display (21) on the device (2). Furthermore, as shown in FIG. 7-4, the clock (210) and the time display (21) can both exist on the portable storage device (2). All the above combinations can be made to fir customer's need.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claim is:

1. A Universal Serial Bus (USB) disk watch comprising
a base for placing a portable storage device, wherein a fitting compartment being formed on one end of the base and a hatch having two corresponding pivot holes being disposed;
a pair of wrist bands to go through two wrist band openings;
a portable storage device having at least a time display, a connector, a time control circuit, a power pack, and a memory module.

2. A USB disk watch as recited in claim 1, wherein the wrist band openings being two symmetrical openings disposed with pivot holes to match rod holes for a pivot rod.

3. A USB disk watch as recited in claims 1, wherein the wrist band openings being two symmetrical openings placed on any two symmetrical lateral sides of the base.

4. A USB disk watch as recited in claims 2, wherein the wrist band openings being two symmetrical openings placed on any two symmetrical lateral sides of the base.

5. A USB disk watch as recited in claim 1, wherein the power pack disposed in the portable storage device providing the main source of power for the time display.

6. A USB disk watch as recited in claim 1, wherein the time display disposed on the portable storage device being a LCD type.

7. A USB disk watch as recited in claim 1, wherein the time display on the portable storage device being a mechanical clock type.

8. A USB disk watch as recited in claim 1, wherein the portable storage device having a connector, a time display, a time control circuit, a memory module and a recharging unit whereby drawing power and recharging when connected to any read-write device to provide power for the time display and time control circuit.

9. A USB disk watch as recited in claim 1, wherein the one side of the portable storage device having time adjustment buttons for time setting and function switching.

10. A USB disk watch as recited in claim 1, wherein on the sides of the portable storage device, two fastening grooves matching two latches on the base for fastening the portable storage device to the base.

11. A USB disk watch as recited in claim 1, wherein the bottom of the hatch having two pivot holes to match the rod holes on the base for the pivot rod to go through the holes thereby fastening the hatch to the base.

12. A USB disk watch having a portable storage device-time display combination fastened to a base in which a fitting compartment being formed whereby a storage device and a clock being disposed and further, on the base forming two symmetrical wrist band openings and a hatch on one end.
